(19) United States
(12) Patent Application Publication
(10) Pub. No.: US 2011/0277502 A1
(43) Pub. Date: Nov. 17, 2011

(54) Pendant button cover with magnetic latch

(76) Inventor: Jay Mark Welikson, Huntington Station, NY (US)

(21) Appl. No.: 13/106,087

(22) Filed: May 12, 2011

Related U.S. Application Data
(60) Provisional application No. 61/395,650, filed on May 17, 2010.

(51) Int. Cl. A44B 1/04; A44C 13/00; H01F 7/02

(52) U.S. Cl. 63/1.18; 24/303

(57) ABSTRACT

A button cover capable of receiving ornamentation having a magnetically held latching system which holds the cover in place over a button easily and reliably. Such a system would allow a user to change button ornamentation quickly and easily with little fear of losing an expensive and decorative pendant.

### CROSS REFERENCE TO RELATED APPLICATIONS

This application claims priority from U.S. provisional application No. 61/395,350 filed 12 May 2010; entitled Pendant Button Cover. The entire contents being hereby included by reference and for which benefit of the priority date is claimed.

### FIELD OF THE INVENTION

The present invention is directed toward ornamentation for clothing and in particular to a button cover for garments.

### BACKGROUND OF THE INVENTION

In the prior art those wishing to dress up their dress cloths have been reticent to incorporate high value ornamentation to their covers in fear that such covers could become separated from the garment and lost. Existing button covers are generally designed as a one piece unit with a hinge joining the button and the holder.

### SUMMARY OF THE INVENTION

In accordance with the present invention, there is provided a button cover which is easy to apply and remove yet holds reliably. The button cover can be used to add bling to a button down shirt face or as a cufflink replacement on a sleeve. The cover is easy to use as one simply places the cover over a button and slides the back in place. Once the back is in proper location to hold fast to the button which is preferably sewn or otherwise attached to the garment, to opposing magnets engage to hold the cover in place to enshroud the button. It is anticipated that the movement of the back would function as a saucer hinge, however other types of hinge or backing arrangement can be envisioned which do not depart from the spirit of the present invention.

It is therefore an object of the invention to provide an ornamental button cover which holds reliably, but is easy to release.

It is therefore an objective of the invention to provide an ornamental button cover which can be made in different sizes.

It is therefore an objective of the invention to provide an ornamental button cover which uses magnetic force a at least a portion of the latching mechanism.

It is therefore an objective of the invention to provide an ornamental button cover which has a redundant latch and catch locking mechanism.

It is therefore an objective of the invention to provide an ornamental button cover which can be opened and closed without the user resulting to using fingernails.

It is therefore an objective of the invention to provide an ornamental button cover which is easy for those with arthritis to use.

It is therefore an objective of the invention to provide an ornamental button cover in which the ornamentation is interchangeable.

### BRIEF DESCRIPTION OF THE DRAWINGS

A complete understanding of the present invention may be obtained by reference to the accompanying drawings, when considered in conjunction with the subsequent, detailed description, in which:

FIG. 1 shows a partial perspective view of an embodiment of a button cover on a button;

FIG. 2 shows an exploded view detailing mechanisms of an embodiment of a button cover of the present invention;

FIG. 3 shows an orthogonal view of an embodiment of the present invention in an open position;

FIG. 4 shows an orthogonal view of an embodiment of the present invention from FIG. 3 in a closed position;

FIG. 5 shows an orthogonal view of an embodiment of the present invention from FIG. 3 in a partially closed position and detailing arcs of travel;

FIG. 6 shows an orthogonal view of the embodiment of FIG. 5 without showing arcs of travel.

FIG. 7 shows an orthogonal view of an alternate embodiment.

### DETAILED DESCRIPTION

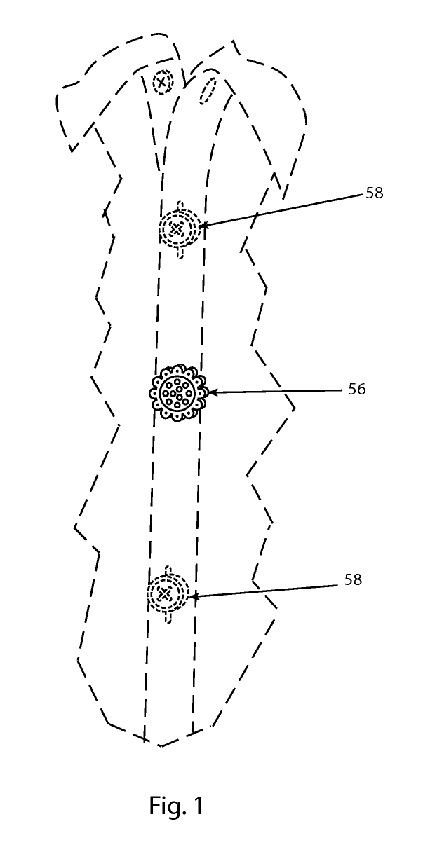

There is generally provided a button cover (56) for ornamenting a button (58) as found on clothing as found in the embodiment of FIG. 1. Generally the non-claimed matter is shown in broken lines in this instant. Generally a button (58) for shirt measures about 1 cm in diameter and 3-4 mm in height. A typical button cover (56) being 2 cm in diameter and having capacity for enshrouding a button (58) into the interior. It is anticipated that the dimensions above can be scaled as desired without departing from the spirit of this invention.

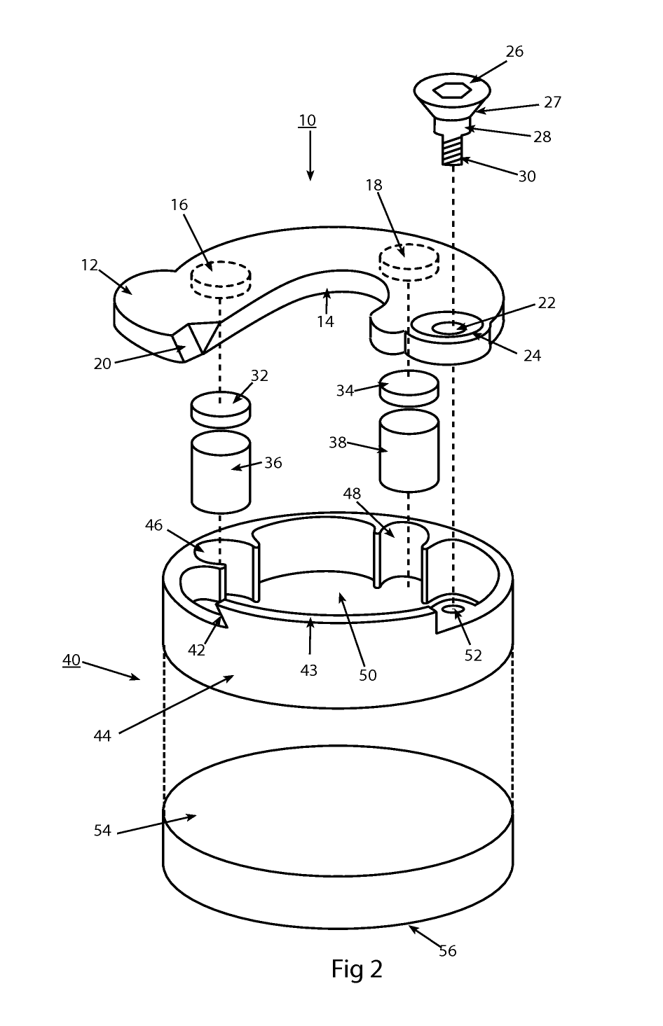

FIG. 2 shows a back member or fastening back (10) having a thumb latch (12) and being generally arched or curvilinear in shape and having a relief (14), preferably arched, for providing a void for the button thread or other such fastening means. A first magnet inset (16) and a second magnet inset (18) are provided for holding a first backing magnet (32) and a second backing magnet (34). The backing magnets (32) (34) being approximately 3 mm in diameter with a thickness of approximately 0.75 mm and having a magnetic strength in the order of 2900-3000 Gauss. The backing magnets (32) (34) being held in the insets (16) (18) by means of an adhesive such as epoxy or cyanoacrylate glue or the like.

The fastening back (10) is made to pivot about a pin or screw, which in this instance, comprises a head (26) having a tool engagement means, a flair (27) for spreading forces, a post (28) for providing a moment of pivot, and in this preferred embodiment, a threaded portion (30) which attaches to a fastener receiver (52), which is typically threaded and held fast by means of an adhesive such as Lock Tight™ or like adhesive. A pivot hole (22) and chamfer (24) are provided for flush setting the head and providing a larger surface to minimize binding.

A base (40) comprising a perimeter (44) being suited to a top (54) are firmly affixed together generally by means of a solder, welding, or gluing process. The base having a void portion (50) comprising a volume suited to encasing a button (58) is provided. The base further comprising a lip (43) preferably comprising a latch (42) opposite the fastener receiver (52) and suited to interface with a catch (20) as provided on the fastening back (10). A first magnet seat (46) and a second magnet seat (48) are disposed for holding a first base magnet (36) and a second base magnet (48) are provided. The location of the first and second base magnets (36) (38) are situated to align with the first and second backing magnets (32) (34) respectively when the fastening back (10) is pivoted or rotated into the closed position, as in FIG. 4. Also the base magnets (36) and (38) and the backing magnets (32) (34) are arranged such that the poles are in opposite orientation, i.e. attracting mode. Those skilled in the art can appreciate that it is anticipated that various arrangements of magnetic orientations can devised to achieve the present objective.

It is also anticipated that base magnets (32) (34) of approximately 3 mm diameter by 3 mm height and comprising approximately 6,000 Gauss would be sufficient for the present purposes. It is anticipated that Neodymium material for all magnets and a stainless steel base (40) are also sufficient.

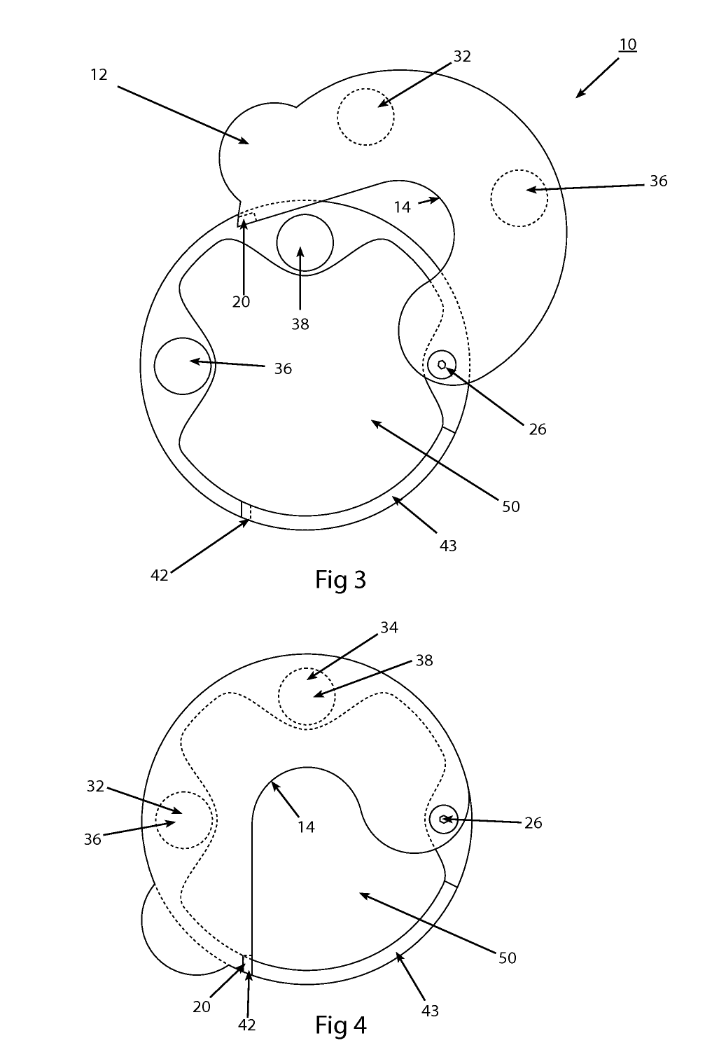

FIG. 3 shows that in the open position, the void portion (50) is fully exposed allowing a button (58), not shown, to seat into the chamber. FIG. 4 shows that with the fastening back (10) rotated into the closed position, forms a closure to enshroud the button (58) holding the ornamentation (56) and the button (58) together. It is preferred that in the closed position that the catch (20) and the latch (42) are engaged to provide an alternative or redundant point of attachment with the pin (28) head (26) combination.

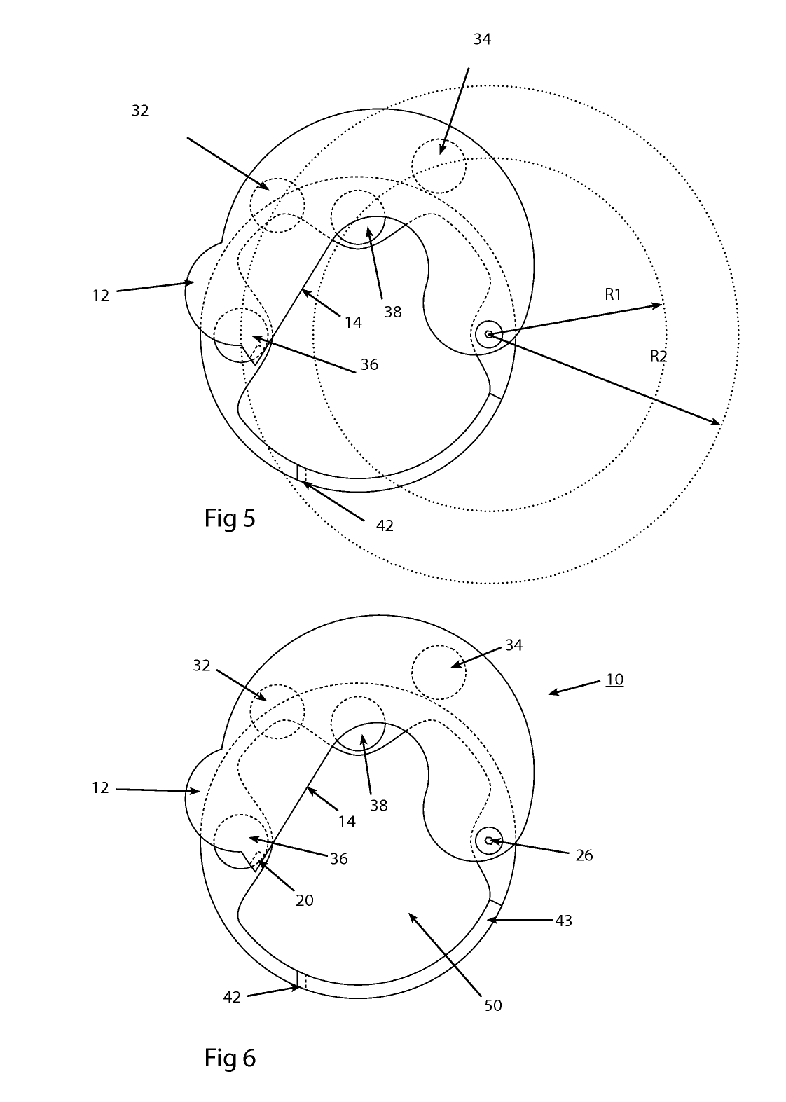

FIGS. 5 and 6 show a fastening back in a partially closed position. It will be noted that, as defined by the pivot head (26), magnets (34) and (38) lie in an arc defined by radius R1 and magnets (32) and (36) lie in an arc defined by radius R2. As backing magnet (32) advances radially past base magnet (38) the two do not interact appreciably as they lie on different radiuses. However, as the fastening back (10) advances to the closed position, backing magnet (32) interacts with base magnet (36) substantially at the same point that backing magnet (34) interacts with base magnet (38). This multiplies the affect of the sets of magnets working in concert to hold the fastening back (10) in the closed position.

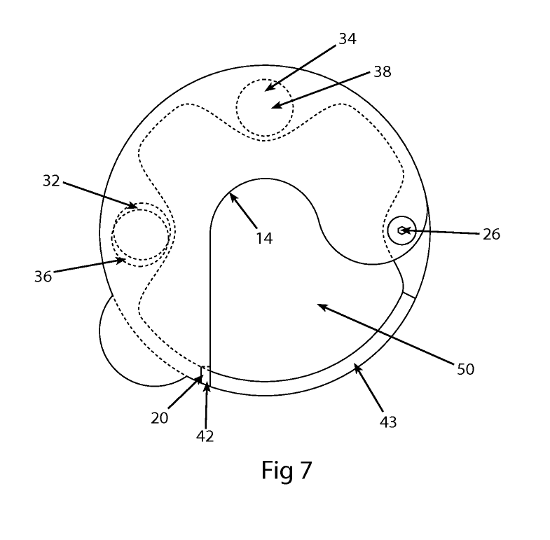

In an alternate embodiment, as shown in FIG. 7, one or more of the base magnets (36) in this case can be advanced to cause a slight over travel of the fastening back (10). The effect being that magnet (32) will be slightly out of equilibrium with magnet (36) in this case providing a motive force for the fastening back (10) to move counter clockwise. This compelling the catch (20) to more securely engage with the latch (42), thus providing a stronger latching force between the latch (42) and the catch (20).

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example, although the foregoing refers to magnets and in particular neodymium magnets, it is contemplated that other magnetic and ferrous materials may be used. Further, shapes and ornamentations may vary from the generally cylindrical forms for example; rectangular, polygonal or the like, and vary in terms of dimensions and exact position of structural members. Depending on the physical arrangement of the structural members such as latches, other arrangements for magnets may be used.

Having thus described the invention, what is desired to be protected by Letters Patent is presented in the subsequent appended claims.

We claim:

1. An ornamental button cover comprising:
(i) a base comprising a perimeter member, the base being affixed to a top, the top being capable of receiving ornamentation;
(ii) the perimeter having a void portion being suited to accommodate a garment button, the base further comprising at least one base magnet,
(iii) the base further comprising a fastener receiver,
(iv) a back member comprising at least one backing magnet, the back member being formed to conform to the back surface of the garment button and having a relief for accommodating the attachment portion of said garment button;
(v) a pin securely affixed at the fastener receiver for rotatably affixing the back member to the base, and
(vi) the back member rotating in relation to the base member about the pin and the at least one base magnet and the at least one backing magnet coordinating to hold the back member in a closed position.

2. An ornamental button cover in accordance with claim 1 further comprising a multiple of backing magnets in the back member, and a multiple of base magnets in the base.

3. An ornamental button cover in accordance with claim 2 wherein at least a first set of magnets and a second set of magnets are arranged to align simultaneously as the back member is rotated into a closed position.

4. An ornamental button cover in accordance with claim 3 wherein the base is permanently affixed to the top.

5. An ornamental button cover in accordance with claim 4 wherein the ornamentation comprises at least one of; precious stones, precious metals, and pendant designs.

6. An ornamental button cover in accordance with claim 5 wherein the base further comprises a catch and the back further comprises a latch, the catch and the latch being arranged such that the catch is seated with the latch when the back member is in a closed position.

7. An ornamental button cover in accordance with claim 6 wherein the catch is overdriven toward the latch.

8. An ornamental button cover in accordance with claim 7 wherein the pin comprises a screw being permanently screwed into the fastener receiver and having a shaft such that the back member pivots freely about the upper portion of the shaft, and having a recessed head.

9. A cover for encasing a button comprising:
(i) a top being capable of receiving ornamentation;
(ii) the top being attached to a base; the base comprising a perimeter, a substantially hollow interior, and at least one base magnet;
(iii) a back member comprising at least one back magnet, the back member forming a fastening relationship with a button when the back member is in a closed position, and releasing the button when the back member is in an open position;
(iv) the back member being rotatably attached to the base at a pivot point such that the at least one base magnet, and the at least one back magnet form an attraction when the back member is in the closed position.

10. A cover for encasing a button in accordance with claim 9 further comprising a first base magnet and a second base magnet and a first back magnet and a second back magnet.

11. A cover for encasing a button in accordance with claim 10 wherein the first base magnet and the first back magnet lie in a different radius from the pivot point than the second base magnet and the second back magnet.
